(19) United States
(12) Patent Application Publication
(10) Pub. No.: US 2010/0076875 A1
(43) Pub. Date: Mar. 25, 2010

(54) SYSTEM AND METHOD FOR PROVISIONING ANTICIPATED TAX REFUND, INCOME OR CONSUMER LOANS

(76) Inventors: Mark A. Ernst, Mission Hills, KS (US); John W. Thompson, Overland Park, KS (US); Bernard M. Wilson, Leawood, KS (US)

Correspondence Address: HUSCH BLACKWELL SANDERS LLP, 4801 Main Street, Suite 1000, KANSAS CITY, MO, 64112, US

(21) Appl. No.: 12/324,394

(22) Filed: Nov. 26, 2008

Related U.S. Application Data
(60) Provisional application No. 61/100,071, filed on Sep. 25, 2008.

(51) Int. Cl. G06Q 40/00

(52) U.S. Cl. 705/31; 705/38

(57) ABSTRACT

A system and method for provisioning a refund anticipation loan is providing that includes receiving tax return information wherein the tax return information is associated with a taxpayer and the tax return information includes an expected refund amount and authorization for a combined bank to receive the expected refund amount, determining whether the expected refund amount meets a threshold value for the RAL, determining whether there is a debt indicator associated with the tax return, requesting an account for the taxpayer from a combined bank wherein the combined bank will also fund the RAL under a the same charter, requesting RAL funding for the taxpayer account from the combined bank if a debt indicator is not associated with the tax return, and receiving the expected refund amount at the combined bank, wherein the RAL is offset by receipt of the expected refund amount at the combined bank.

### CROSS-REFERENCE TO RELATED APPLICATIONS

This application claims priority to and the benefit of U.S. Provisional Application Serial No. 61/100,071, filed Sep. 25, 2008, which document is hereby incorporated by reference to the extent permitted by law.

### BACKGROUND OF THE INVENTION

Short term loans, such as a refund anticipation loan (a “RAL”), a refund anticipation check (a “RAC”), or other consumer loan have become relatively common during tax season. Accordingly, many tax preparation retailers offer various forms of RAL and RAC services for those customers who qualify and would like to receive their tax refund earlier than the Internal Revenue Service advances it. Provision of RALs and RACs are generally done via arrangement between one or more tax preparation retailers, a bank to fund the loan, and a different bank or other entity with which the proceeds of the loan are actually dispersed, generally in the form of a check.

Before a RAL is approved, some underwriting information and other operations are carried out. When a RAL is requested, for example, a threshold assessment is generally performed by checking with the IRS to determine whether or not there is a debt indicator (“DI”), such as a lien, against the customer's tax return. The lending bank is made aware of any loans or liens against the client and the lending bank then determines whether or not it has the financing capacity to lend the requested funds to the borrower.

If the loan is made, the lending bank prepares to collect on the loan by opening a temporary bank account in another bank or lending institution for the borrower to receive electronic deposit of the anticipated tax refund from the IRS. The documents signed by the borrower instruct the IRS to direct deposit the refund into that account. The contract between the taxpayer and the lending bank usually contains a right of setoff such that the lender is repaid when the refund appears in the bank's account. The consumer is liable for the full amount of the loan if the refund is disallowed in whole or in part. The refund amount would be affected if, for example, the IRS disallows a deduction or if there is an intercept of the refund for back child support payments or a student loan debt.

The temporary account opened by the bank is strictly for the purpose of receiving the tax return payment from the IRS into that account. The check is facilitated by the tax preparation retailer usually one or two days after the tax refund is direct deposited by the IRS. Thus, other than to receive funds from the IRS, the temporary bank account does not provide any other benefits for the taxpayer since the taxpayer does not have permanent use of the account and has none of the typical privileges associated with a standard banking account. After receipt of the refund monies from the IRS, the lending bank then closes the temporary bank account and marks the refund anticipation loan as paid.

One of the disadvantages of the RAL options presently available to taxpayers is that RAL products tend to include relatively high fees to the taxpaying consumer. For example, due to the number of entities involved, the taxpayer consumer typically pays a fee to the lending bank and the tax preparer. These fees are often called “system administration,” “application,” “document preparation,”, “refund account fees,” or “e-filing” fees. Thus, consumers typically pay $100 or more, not including standard tax preparation fees, for a refund anticipation loan and for a bank account that is open for only 7-15 days and that is solely created to issue a single check or to get a prepaid card.

Another downside to current RAL options is that there are a number of factors that may serve to restrict a taxpayer's ability to receive a RAL, even if the taxpayer is qualified and eligible for one. It will be appreciated that there are relatively few money center banks with the ability and/or capacity to lend the large sums of money necessary to fund RAL loans to a substantial number consumers at any given time, much less during the credit crunch that occurs at times when loans are in high demand such as during tax season. Therefore, it is quite possible that a taxpayer may not be able to receive RAL funds, despite being otherwise qualified and eligible.

Alternatives to RAL product offerings, including check disbursement, are available and often take the form a stored value card. A stored value card works like a debit card to make purchases and withdraw cash, but is not linked to a regular bank account. Issuers of stored value cards include both banking and non-banking entities (“host banks”). Accordingly, these programs vary widely in terms of the cost, convenience, and level of consumer protection. For example, it is possible that the holder of a stored value card could lose the money “stored” on the card in the event that a host bank goes out of business due to the lack of a variety of consumer protections. Indeed some permanent account options have been provided in the marketplace but all of those options continue to utilize a temporary account for the loan and a separate host bank account for the proceeds and debit or stored value card usage.

Accordingly, it is desirable to provide a method and system which reduces the likelihood RAL funds will not be available. It is also desirable to provide a system and method of providing RAL products with additional account options.

Similarly, upon request for a RAC, a temporary bank account is opened by the host bank strictly for the purpose of receiving the tax return payment from the IRS into that account. The money is then disbursed to the tax preparation retailer through a check one or two days after the tax refund is direct deposited into the temporary bank account by the IRS. Thus, other than to receive funds from the IRS, the temporary bank account does not provide any other benefits for the taxpayer since the taxpayer does not have permanent use of the account and has none of the typical privileges associated with a standard banking account. Upon the check clearing and being honored and paid by the host bank the temporary account is closed.

One of the disadvantages of the RAC options presently available to taxpayers is that RAC products tend to include relatively high fees to the taxpaying consumer. For example, due to the number of entities involved, the taxpayer consumer typically pays a fee to the tax preparer, the host bank and check cashing retail outlets. These fees are often called “system administration,” “application,” “document preparation,” “refund account”, “check”, or “e-filing” fees. Thus, consumers typically pay, not including standard tax preparation fees, over $100 to receive and cash a check solely to receive their refund.

Accordingly, it is desirable to provide a method and system which provides for RACs or refunds where no loan is requested to be deposited into newly established permanent bank accounts at a single bank or within the same charter. It is also desirable to provide a system and method of providing RAC or refund deposit products with additional account options.

### SUMMARY OF THE INVENTION

There is, therefore, provided in the practice of the invention a computer readable storage medium having stored thereon executable program code for implementing a method for provisioning a loan, such as a RAL, a RAC, income loan or other consumer loan, that, when the program code is executed, is operable to perform a method including the steps of receiving tax return information where the tax return information is associated with a taxpayer and the tax return information includes an expected refund amount and authorization for a lending bank, to receive the expected refund amount, determining whether the expected refund amount meets a threshold value for the loan, determining whether there is a debt indicator, such as a negative or positive DI or other credit approval criteria known in the art, associated with the tax return, requesting an account for the taxpayer whereby the lending bank also acting as the host bank (“combined bank”) will also fund the loan under a single charter, requesting loan funding for the taxpayer account from the combined bank if a debt indicator is not associated with the tax return, and receiving the expected refund amount at the combined bank, wherein the loan is offset by receipt of the expected refund amount, at the combined bank.

In accordance with still another embodiment of the present invention, the taxpayer account is of a prescribed type. In accordance with still another embodiment of the present invention where the tax return information is provided by a referring retail tax preparer, preparation firm or electronic return originator. In accordance with still another embodiment of the present invention the information could be provided by an agent of the tax preparation entity.

In accordance with another aspect of the present invention, a computer readable storage medium is provided, having stored thereon executable program code for implementing a method for provisioning a refund anticipation loan, a refund anticipation check or other consumer loan that, when the program code is executed, is operable to perform a method including the steps of receiving tax return information wherein the tax return information is associated with a taxpayer and the tax return information includes an expected refund amount and authorization for a combined bank to receive the expected refund amount on behalf of the client, determining whether there is a debt indicator, opening a permanent bank account for the client within the combined bank wherein the combined bank will also fund the loan within the same charter; and requesting loan funding for the taxpayer account within the same, and receiving the expected refund amount at the combined bank, wherein the non-loan or refund proceeds funding occurs by receipt of the expected refund amount at the combined bank.

In accordance with yet another embodiment of the present invention, a system is provided for provisioning an income, consumer or tax refund anticipation loan comprising means for receiving tax return information where the tax return information is associated with a taxpayer and the tax return information includes an expected income or refund amount and authorization for a combined bank to receive the expected income or refund amount, means for determining whether or not there is a negative DI or other negative credit criteria, as understood in the art, associated with the tax return, means for requesting an account for the taxpayer within a combined bank in the same charter, means for requesting loan funding for the permanent bank account if a debt indicator is not associated with the tax return, and means for receiving the expected refund amount within the permanent bank account, wherein the loan funding is offset by receipt of the expected refund amount in the permanent bank account.

The foregoing needs are met, to a great extent, by the present invention, wherein in one aspect an apparatus is provided that, in some embodiments, the tax return information is provided by a retail tax preparer, tax preparation firm or electronic return originator or a tax software program, or tax preparation website.

Certain embodiments of the invention are outlined above in order that the detailed description thereof may be better understood, and in order that the present contributions to the art may be better appreciated. There are, of course, additional embodiments of the invention that will be described below and which will form the subject matter of the claims appended hereto.

In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE SEVERAL VIEWS OF THE DRAWING

Further features of the present invention will become apparent to those skilled in the art to which the present invention relates from reading the following description with reference to the accompanying drawings, in which:

FIG. 1 illustrates a communications network environment in which an embodiment of the present inventive method and system may operate;

FIG. 2 illustrates a communications network environment with block component view of an entity communicating thereon in accordance with an embodiment of the inventive system and method;

FIG. 3 shows a flow chart illustrating steps that may be followed to create an account in accordance with an embodiment of the inventive system and method;

FIG. 4 shows a flow chart illustrating steps that may be followed to provision a RAL in accordance with an embodiment of the inventive system and method; and

FIG. 5 shows a flow chart illustrating steps that may be followed to receive payment for a RAL in accordance with an embodiment of the inventive system and method.

### DETAILED DESCRIPTION OF THE INVENTION

The invention will now be described with reference to the drawing figures, in which like reference numerals refer to like parts throughout. An embodiment in accordance with the present invention provides a system and method for provisioning anticipated income, consumer or tax refund loans for third party clients via creation of accounts of prearranged types with participating host banks. For illustrative purposes, an embodiment of the invention is discussed below with reference to entities communicating about the provision of anticipated income, consumer or tax refund loans over a network as a platform. This is only an example of an operating environment, and is not intended to suggest any limitation in the scope of using or functionality of the invention. Neither should it be interpreted as implying any dependency or necessity of any one or combination of components illustrated in the exemplary operating environment. Moreover, for ease of explanation and for illustrative purposes only, embodiments of the invention are discussed hereinbelow in reference to RALs. However, it will be appreciated by one skilled in the art that any type of income or consumer loan including RALs and RACs may be used in connection with the present invention without departing from the scope hereof.

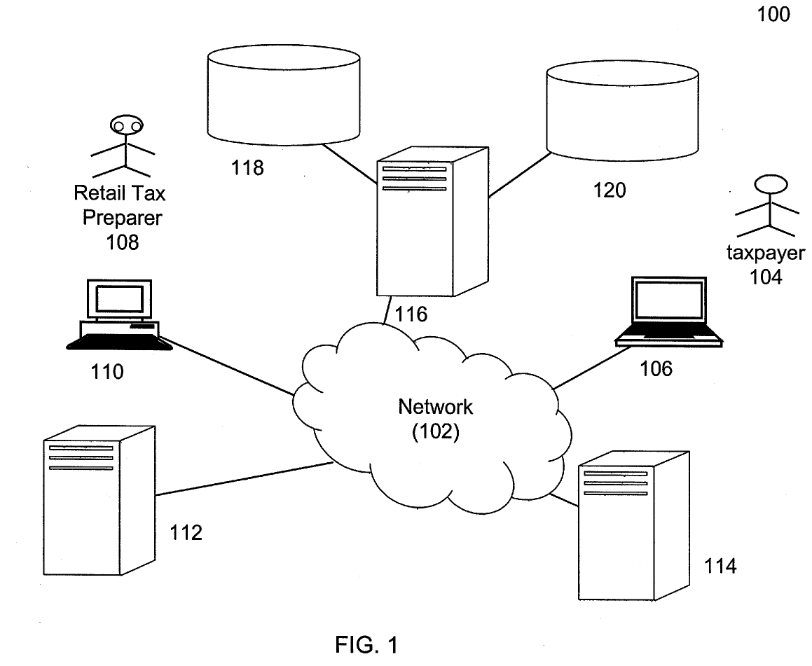

FIG. 1 illustrates one such operating environment 100 as an embodiment of the invention, in which one or more users such as taxpayer 104 or retail tax preparer 108 may use one or more communication devices 106, 110, 112, 114, 116 operating over an interconnected network 102 of devices. The communication devices 106, 110, 112, 114, 116 should be broadly construed to be or include, for instance, personal computers, traditional telephones communicating via plain old telephone service (POTS), wireless mobile phones, personal digital assistants (PDAs), Smartphones, smart devices, tablet computers, scanners, facsimile machines, video phones, webcams, communication appliances, or other mobile devices, voice over Internet Protocol (VoIP) clients, telephones connected via dedicated or switched wired broadband data communications services such as DSL, cable modem, T1, PRI or BRI ISDN lines, wireless data communications services, public or private networks, computers, thin clients, or other communication devices. Additionally, it should be understood that one or more communications devices may be running or hosting software applications for providing certain features.

It will be further understood by one of skill in the art that one or more of the communication devices 112, 106, 116, etc. may operate and provide application and/or data servers access and functionality. The network 102 may be a distributed network which may be implemented as an intranet, a local area network (LAN), or a wide area network (WAN) such as the Internet. Additionally, the network 102 may also be the medium used to provide communications links between network-connected devices and may include switches, routers, hubs, wired connections, wireless communication links, or fiber optic cables. Communication devices 116, 112 may include one or more data repositories 118, 120. Data repositories 118, 120 may include, for example, IRS taxpayer information, non-governmental credit tracking and reporting information, contact information, and the like.

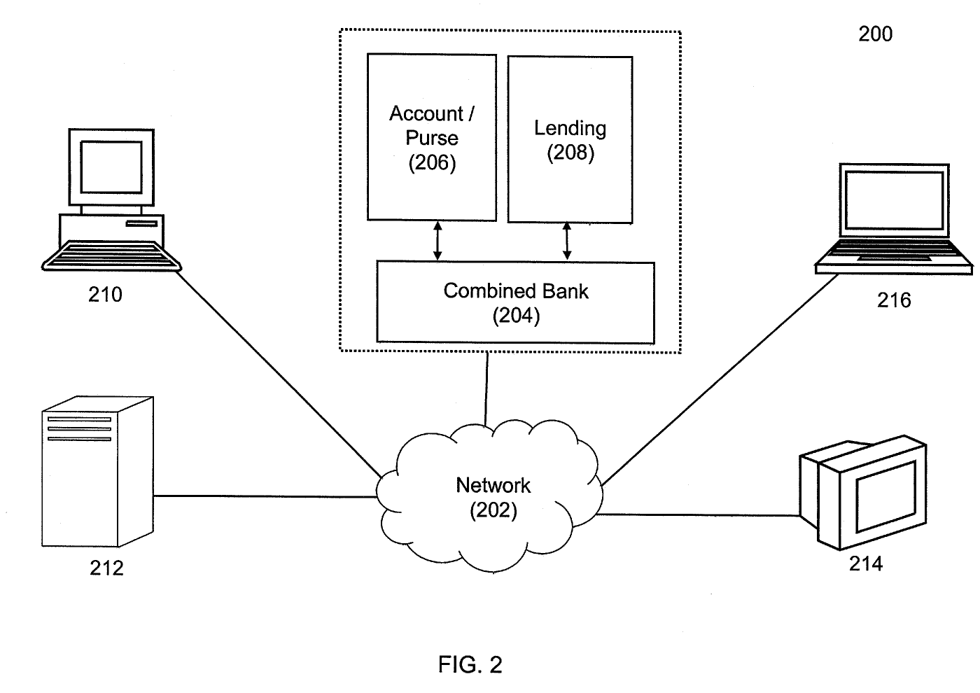

FIG. 2 illustrates a communications network environment 200 with a block component view of an entity communicating thereon in accordance with an embodiment of the inventive system and method. While FIG. 2 shows networked devices 210, 212, 214, and 216 connected using a network 202, it should be understood that network connected components 212 may reside on the same computer or private network. A computer should be broadly construed to mean any device capable of processing or accessing information such as a pc, server, mini-computer, workstation, personal digital assistant (PDA) or terminal.

In block 204, combined bank is shown. Combined bank 204 includes several financial services divisions operating under a single charter. For example, combined bank 204 provides various account services 206, including demand deposit accounts (“DDAs”), commonly known as a checking account, in which an account is provided from which a depositor may withdraw funds immediately without prior notice. Since funds may be withdrawn on demand in person or by presentation of a check, the account has many of the liquid characteristics of circulating currency.

In addition to providing accounts 206, combined bank 204 provides lending services 208 under a common charter. Providing several different banking services under the same charter offers some options not previously available in the refund anticipation loan industry. In addition to common account types, some institutions offer specialized bank accounts such as a Christmas Club savings account which provides for provide short-term savings while restricting withdrawals before a certain point in time to encourage/enforce saving on the part of the account holder. For example, a customer opens a Christmas Club savings account in January. The account is left open through the end of October, at which time the customer can withdraw the money on the first of November, thus ensuring at least some funds for that season's holiday shopping.

The client holds a prescribed, tailored bank account that is FDIC insured and Regulation E protected, and is provided with a debit card or the like which allows that client to use the card via point of sales swipes, ATMs, etc., like any other card product. The combined bank keeps the loan account open for the taxpayer client or maintains their loan account but then opens a depository transaction account such as a checkless DDA in the same charter. Thus, the combined bank now has both a loan as well as a deposit that offsets the amount of the loan.

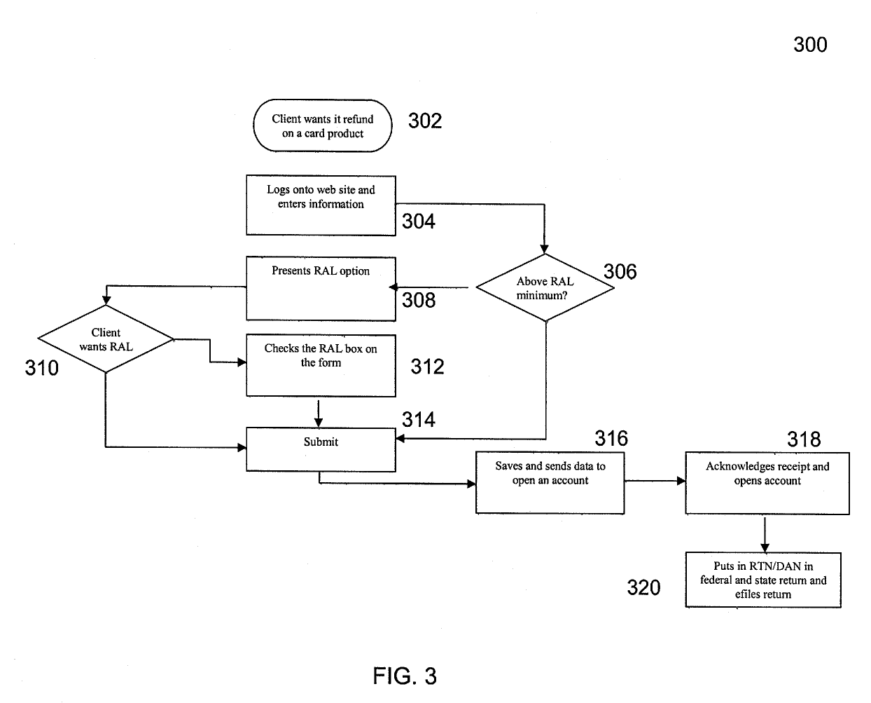

FIG. 3 shows a flow chart 300 illustrating steps that may be followed to create an account in accordance with an embodiment of the inventive system and method. It will be appreciated by one of skill in the art that the steps and operations described herein may be implemented as web services, thin client applications, java applets, web 2.0 mash-ups, and the like. It should also be noted that communication and information exchange may be carried out using various protocols including challenge/response, one or more factor token authentication, tokenless authentication, VPNs, certificate authentication, shifting keys validation protocols including encryption, public key encryption, hashes, checksums, SSL, HTML, XML, Ajax, JavaScript, flash, SilverLight, email, EDI, FTP, SFTP, bittorrent, distributed systems, and the like. Embodiments of the inventive method and system feature a modular design, thus allowing for updates and modifications based on future requirements and advances in technology.

In block 302, it is show that a tax preparation client (“taxpayer”) desires to have its tax refund placed in the permanent bank account accessed through a card product. In block 304, the taxpayer is shown to be entering taxpayer information into a web based form. It will be appreciated that information entered by the user will likely include some form of universal identification, such as a government issued id card, social security number, green card, and the like. Additionally, the taxpayer will provide tax refund information in order to request that the refund be placed on the tax payer's card. In block 306, a check is performed to determine whether or not the anticipated refund amount exceeds some predetermined threshold amount to qualify for a RAL. It will be appreciated that the threshold amount in block 306 may be varied based on a number of criteria. For example, the threshold RAL value may be based on the time of year, general availability of lending funds, identity of the referring party, geographic location of the taxpayer, and/or general availability of funds for lending by participating host banks in within a certain geographic area of the taxpayer.

In cases where the threshold is met, as shown in block 308, the taxpayer is shown that a RAL is an option. In block 310, a determination is made as to whether or not the taxpayer wants a RAL. If this is the case, then the taxpayer selects the RAL option on the form as shown in block 312. In block 314, the form is submitted. Returning to block 306, if the anticipated refund amount does not meet the threshold, then the taxpayer arrives at block 314 where the form is submitted. Per block 316, taxpayer information is saved and a request to open an account for the taxpayer is the sent to a partner host bank. In block 318, the bank acknowledges receipt the request to open an account and confirms that an account has been opened for the taxpayer. Per block 320, the taxpayer permanent bank account accessed through a card product and federal and state tax returns are electronically filed.

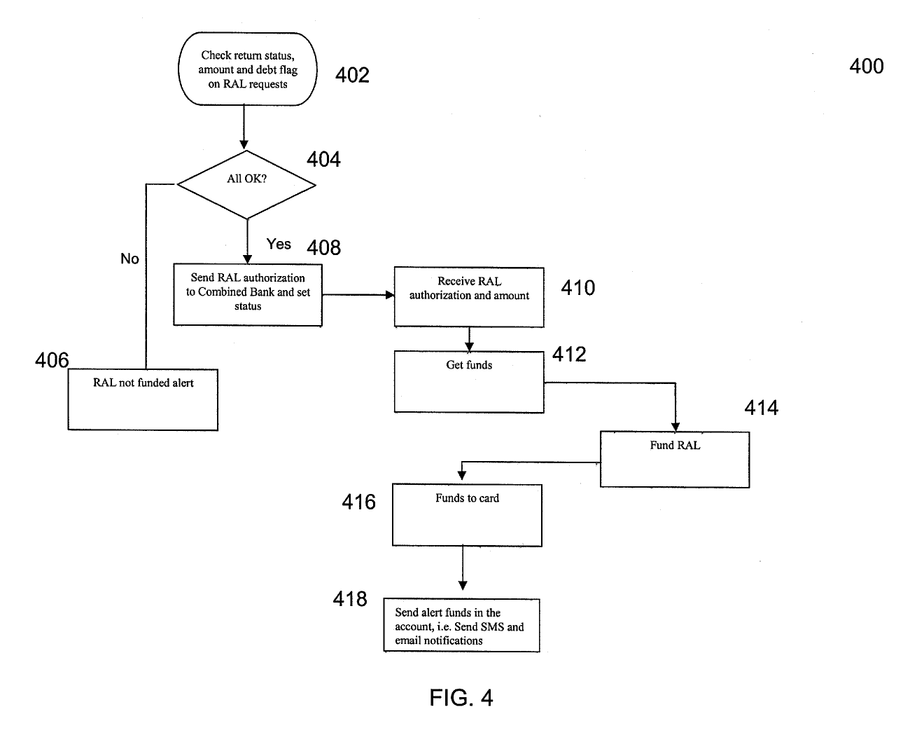

FIG. 4 shows a flow chart 400 illustrating steps that may be followed to provision a RAL in accordance with an embodiment of the inventive system and method. In block 402, the tax return status is checked along with the amount of the return, and a check is made to determine whether or not there is a debt indicator attached to the tax refund or other negative credit indication. Per block 404, if the DI check indicates that the taxpayer does not have a DI or any DI is within acceptable parameters prescribed by the combined bank, a RAL authorization is sent to the combined bank per block 408. In the event the checks performed per block 404 are not ok, then according to block 406, an alert message is sent out to inform all concerned the RAL has not been funded. Concerned parties may include the originator of the taxpayer referral, the taxpayer, and host bank. Returning to block 408, the status of the RAL is changed to indicate that it has been funded. In block 410, in response to the notification sent to the account division of the combined bank, RAL authorization is received along with the amount of the RAL. In block 412, a request is submitted to the lending division of combined bank for the RAL funds. In block 414, the lending division of the combined bank funds the RAL and funds are transferred to the taxpayer account in block 416. Per block 418, messages are sent out to alert those involved that funds are available in the taxpayer's account.

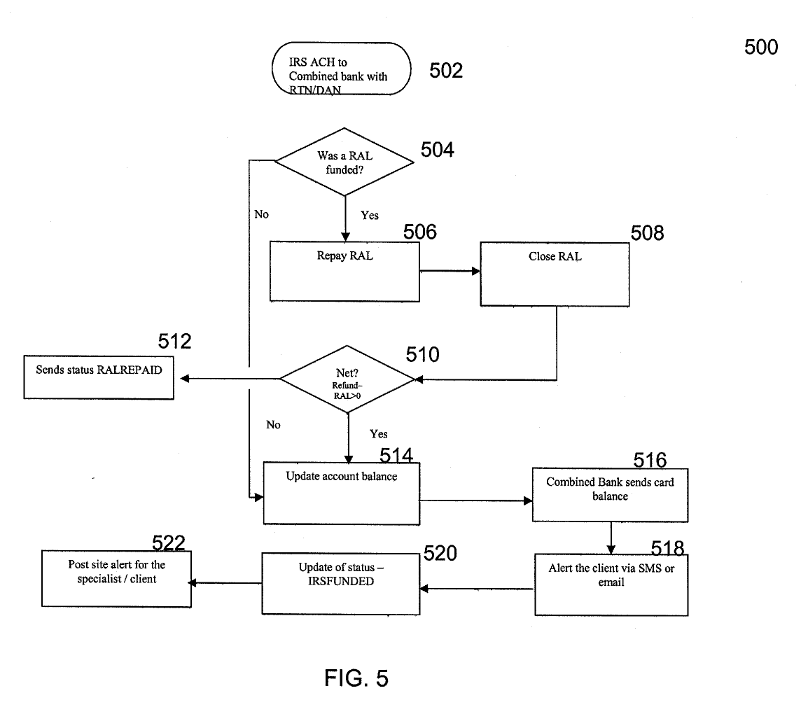

FIG. 5 shows a flow chart 500 illustrating steps that may be followed to receive payment for a RAL in accordance with an embodiment of the inventive system and method. In block 502, the IRS electronically transfers the tax return funds to the combined bank. In block 504, a determination is made as to whether or not the RAL was funded. If yes, per block 506, the RAL is netted within the combined bank account and in block 508, the RAL is closed. It should be noted, however, that the taxpayer client bank account remains open. In block 510, a if the taxpayer refund amount less the RAL amount is greater than zero, then according to block 512, a message is sent out to indicate that the RAL has been repaid.

Returning to block 504, if a RAL was not funded, then per block 514, the taxpayer account balance is updated with the funds from the tax refund. In block 516, the combined bank sends notice of the new account balance and, in block 518, a message or other alert is sent out. In block 520, the system is notified that the status of the RAL is updated to reflect that the IRS has funded the tax refund. In box 522, a message indicating the same is sent to the taxpayer and/or the referred of the taxpayer.

It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative, and not in a limiting sense.

According to one embodiment of the present invention, the method is implemented as a computer program, namely, as a set of instructions executed by a processor. Thus, for example, the method may be a cross-platform java application, a standalone application written in native code, a distinct process built into a server, or part of an application server accessible via thin client or web browser functionality. One of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer readable storage medium having stored thereon executable program code for implementing a method for provisioning a loan that, when the program code is executed, is operable to perform a method comprising the steps of:
receiving tax return information wherein said tax return information is associated with a taxpayer and said tax return information includes an expected refund amount and authorization for a combined bank to receive said expected refund amount;
determining whether said expected refund amount meets a threshold value for said loan;
determining whether there is a debt indicator associated with said tax return;
requesting an account for said taxpayer from said combined bank wherein said combined bank also funds the loan under a single charter;
requesting loan funding for said taxpayer account from said combined bank if said debt indicator is not associated with said tax return; and
receiving said expected refund amount at said combined host bank, wherein said loan funding is offset by receipt of the expected refund amount at said combined bank.

2. The computer readable storage medium of claim 1 wherein said account requested for said taxpayer is of a prescribed type.

3. The computer readable storage medium of claim 1 wherein the step of requesting funding for said loan from said combined bank if a debt indicator is not associated with said tax return further comprises notifying said taxpayer that said loan funds are available in said taxpayer account.

4. The computer readable storage medium of claim 1 wherein said tax return information is provided by a retail tax preparer.

5. The computer readable storage medium of claim 1 wherein said tax return information is provided by a tax preparation software program.

6. The computer readable storage medium of claim 1 wherein said tax return information is provided by a tax preparation website.

7. A computer readable storage medium having stored thereon executable program code for implementing a method for provisioning a loan that, when the program code is executed, is operable to perform a method comprising the steps of:
receiving tax return information wherein said tax return information is associated with a taxpayer and said tax return information includes an expected refund amount and authorization for a combined bank to receive said expected refund amount;
determining whether or not there is a debt indicator associated with said tax return;
requesting an account for said taxpayer from a combined bank wherein said host bank will also fund said loan under the same charter;
requesting loan funding for said taxpayer account from said combined bank if said debt indicator meets prescribed criteria; and
receiving said expected refund amount at said combined bank, wherein said loan funding is offset by receipt of the expected refund amount at said combined bank.

8. The computer readable storage medium of claim 7 wherein the step of requesting funding for the loan from said combined bank if a debt indicator is not associated with said tax return further comprises notifying said taxpayer that said loan funds are available in said taxpayer account.

9. The computer readable storage medium of claim 7 wherein said tax return information is provided by a third party tax preparer.

10. The computer readable storage medium of claim 9 wherein said third party tax preparer is a retail tax preparation franchise.

11. A system for provisioning a loan comprising:
means for receiving tax return information wherein said tax return information is associated with a taxpayer and said tax return information includes an expected refund amount and authorization for a combined bank to receive said expected refund amount;
means for determining whether or not there is a debt indicator associated with said tax return;
means for requesting an account for said taxpayer from a combined bank wherein said combined bank will also fund the loan under a the same charter;
means for requesting loan funding for said taxpayer account from said combined bank if a debt indicator is within prescribed criteria; and
means for receiving said expected refund amount at said combined bank, wherein said loan funding is offset by receipt of the expected refund amount at said combined bank.

12. The system of claim 11 wherein said means for requesting funding for the loan from said combined bank if a debt indicator is not associated with said tax return further comprises means for notifying said taxpayer that said loan funds are available in said taxpayer account.

13. The system of claim 11 wherein said tax return information is provided by a third party tax preparer.

14. The system of claim 13 wherein said third party tax preparer is a retail tax preparation franchise.

15. The system of claim 1 wherein said loan is a short-term loan selected from the group consisting of refund anticipation loans, refund anticipation checks, income loans, and consumer loans.

16. The system of claim 7 wherein said loan is a short-term loan selected from the group consisting of refund anticipation loans, refund anticipation checks, income loans, and consumer loans.

17. The system of claim 11 wherein said loan is a short-term loan selected from the group consisting of refund anticipation loans, refund anticipation checks, income loans, and consumer loans.
